(19) United States
(12) Patent Application Publication
(10) Pub. No.: US 2009/0161542 A1
(43) Pub. Date: Jun. 25, 2009

(54) RESOURCE AVAILABILITY INFORMATION SHARING (RAIS) PROTOCOL

(76) Inventor: KAH KIN HO, Buchs (CH)

Correspondence Address: PATTERSON & SHERIDAN, LLP/CISC, 3040 POST OAK BLVD., SUITE 1500, HOUSTON, TX, 77056-6582, US

(21) Appl. No.: 11/963,143

(22) Filed: Dec. 21, 2007

(51) Int. Cl. G08C 15/00; H04L 12/56

(52) U.S. Cl. 370/231; 370/400; 370/401

(57) ABSTRACT

The present disclosure provides a technique for propagating resource availability information in a network. The technique generally includes storing resource availability information indicating end to end bandwidth availability on multiple paths between the apparatus and a destination in a network and calculating the end to end bandwidth availability based on resource capacity information received from network nodes along the multiple paths.

### TECHNICAL FIELD

The present disclosure relates generally to networks and, more particularly, to availability of resources in networks.

### BACKGROUND

The Resource Reservation Protocol (RSVP) is a network-control protocol that enables Internet applications to obtain differing qualities of service (QoS) for their data flows. Such a capability recognizes that different applications have different network performance requirements. For example, more traditional interactive and batch applications typically require reliable delivery of data but do not impose any stringent requirements for the timeliness of delivery. In contrast, newer application types, including videoconferencing, IP telephony, and other forms of multimedia communications require data delivery that is timely, but not necessarily reliable.

RSVP is intended to provide IP networks with the capability to support the divergent performance requirements of differing application types. RSVP works in conjunction with routing protocols and installs the equivalent of dynamic access lists along the routes that routing protocols calculate to ensure the requirements of a particular application are met. The process of performing a “call setup” with RSVP to ensure resources are available may take some time. The call setup time may be up to hundreds of milliseconds depending on number of hops the setup message has to go through.

Unfortunately, in the event the call setup fails because resources are not available, this time is wasted.

### Overview

One embodiment provides an apparatus generally including a resource capacity table for storing resource availability information indicating end to end bandwidth availability on multiple paths between the apparatus and a destination in a network and resource availability logic configured to calculate the end to end bandwidth availability based on resource capacity information received from network nodes along the multiple paths.

One embodiment provides a method. The method generally includes receiving a first available capacity value indicative of available bandwidth between a first neighboring network node and a network destination, calculating a first derived capacity value indicative of available capacity through the first neighboring network node to the network destination by applying a minimum function to the first available capacity value and a local link remaining capacity (LLRC) value indicative of available network capacity on a local link to the first neighboring network node, calculating a first local available capacity value to advertise by selecting from a group of one or more derived capacity values including at least the first derived capacity value, and advertising the first local available capacity value to one or more neighboring network nodes.

One embodiment provides an apparatus generally including an interface for communicating with neighboring network nodes and logic configured to receive available capacity values advertised by one or more of the neighboring network nodes, calculate derived capacity values indicative of actual available capacity through the one or more neighboring network nodes to the network destination, and advertise the derived capacity value that has the maximum value to one or more network nodes as the available capacity to the network destination through the apparatus.

One embodiment provides an apparatus generally including a resource capacity table for storing resource availability for one or more neighboring nodes, a resource availability information sharing process configured to receive available capacity values advertised by one or more of the neighboring network nodes indicating end to end bandwidth available between the neighboring network nodes and a network destination, calculate derived capacity values indicative of actual available bandwidth through the one or more neighboring network nodes to the network destination, advertise a maximum derived capacity value to one or more network nodes as the end to end available capacity to the network destination through the apparatus, and update the resource availability information in the resource capacity table, and a call routing process configured to consult the resource capacity table prior to initiating a call.

One embodiment provides an apparatus generally including means for storing resource availability information indicating end to end bandwidth availability on multiple paths between the apparatus and a destination in a network and means for calculating the end to end bandwidth availability based on resource capacity information received from network nodes along the multiple paths.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only typical embodiments of this disclosure and are therefore not to be considered limiting of its scope, for the disclosure may admit to other equally effective embodiments.

FIG. 1 illustrates an example network in which embodiments of the present disclosure may be utilized.

FIGS. 2A and 2B illustrates example operations for resource availability information sharing (RAIS) in accordance with embodiments of the present disclosure.

FIGS. 3A-3I illustrate example data flow for resource availability information sharing (RAIS) in accordance with embodiments of the present disclosure.

FIGS. 4A-4F illustrate the impact on RAIS when a network node with superior path metrics are added, in accordance with embodiments of the present disclosure.

FIGS. 5A-5D illustrate the impact on RAIS when a network node with inferior path metrics are added, in accordance with embodiments of the present disclosure.

FIGS. 6A-6D illustrate RAIS with multiple application IDs in accordance with embodiments of the present disclosure.

FIGS. 7A-7F illustrate RAIS during an example call session in accordance with embodiments of the present disclosure.

### DESCRIPTION OF EXAMPLE EMBODIMENTS

Embodiments of the present disclosure may reduce the time required for establishing application sessions between a source and a destination by sharing resource availability information across a network. When all nodes have resource availability information to all destinations, they can make intelligent decisions in routing and re-routing traffic. For example, this sharing of resource availability may allow the determination of which paths have enough bandwidth available to support a call setup (e.g., an RSVP call setup) before the actual call setup takes place. This early determination may help avoid wasting time that results when call setup is initiated only to have the call setup fail if a path does not exist with sufficient resources to support the call.

The techniques described herein may help improve utilization of all available bandwidth in the network for call setup. Because conventional techniques, such as RSVP call setup, typically select the shortest path, if the shortest path has insufficient resources call setup will fail. The techniques described herein, however, allow for more intelligent path decision based on a global network view of available bandwidth, not just based on a shortest path. As a result, networks utilizing the techniques described herein may also experience lower call setup times and higher call setup success rates.

### An Example Network Environment

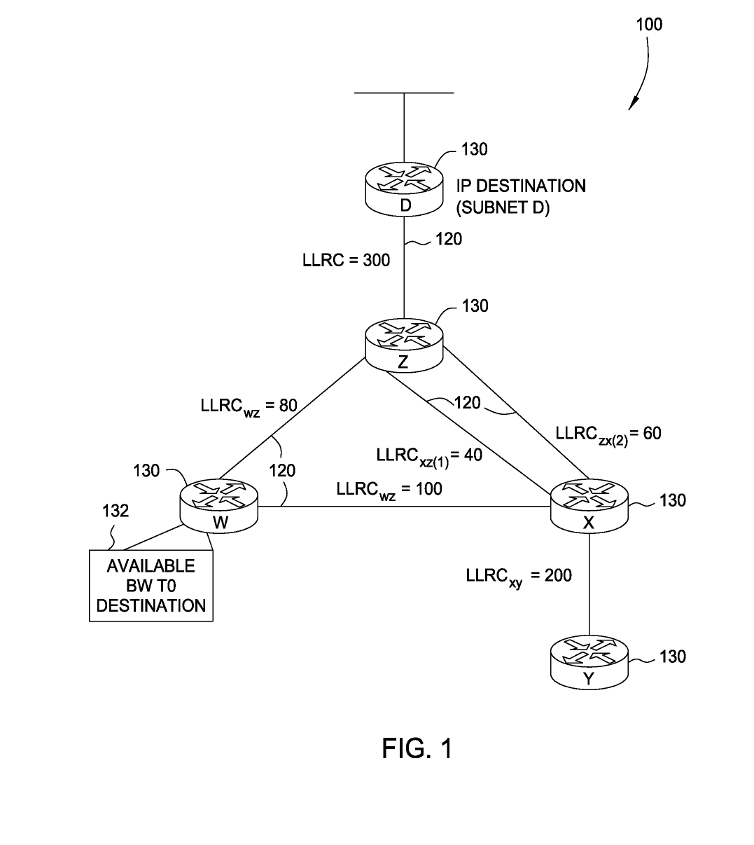

FIG. 1 illustrates one example of a network environment 100, in which embodiments of the present disclosure may be utilized. A collection of network nodes 130 (nodes D, Z, W, X, and Y) may be configured to make decisions regarding how to route and reroute network traffic, such as voice calls, based on “coverall view” of capacity in the network that is gained through resource availability information sharing (RAIS).

As illustrated, the nodes 130 communicate via an interconnection of links 120. As illustrated, some nodes may be connected by more than one link, as are nodes Z and X. Each node 130 may construct and maintain a Resource Availability Information Sharing (RAIS) data structure 132 that represents an overall view of available capacity in the network to different network destinations. The RAIS data structure 132 may allow nodes initiating a call setup to determine if a path with sufficient resources to support the call exists, before the actual call setup takes place.

As will be described below, each node may construct and maintain its own RAIS data structure 132 based on resource availability to destinations advertised by neighboring nodes (neighbors) and a remaining capacity available on links to those neighbors. Local link remaining capacity (LLRC) takes into account capacity that has already been allocated and may be expressed in any suitable units, such as Mbps. For example, while RSVP allocates portions of the bandwidth pool used for reservation, the LLRC value represents what is remaining of the pool. Example values for LLRC between the nodes is shown in FIG. 1 next to each link 120. In operation, LLRC values may be increased or decreased to reflect changes in available capacity, for example, in response to RSVP call setup or tear down.

### Resource Availability Information Sharing (RAIS)

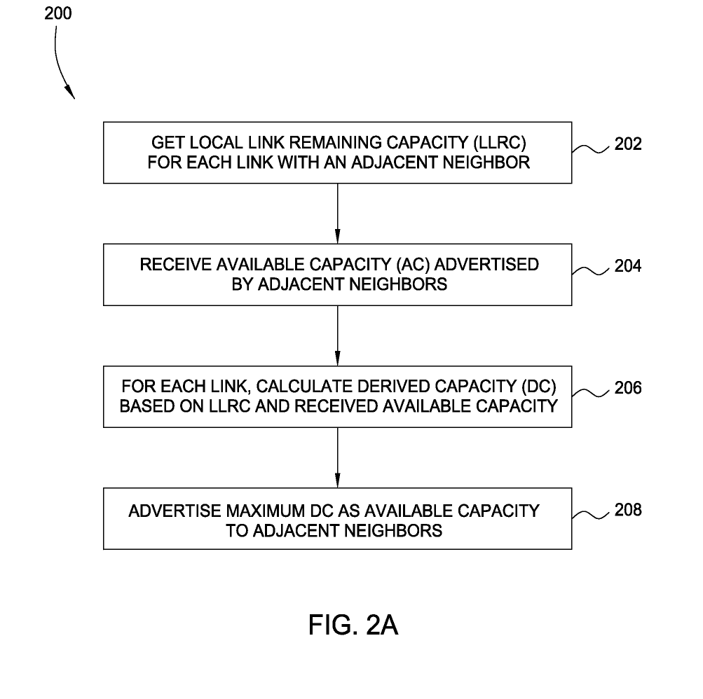

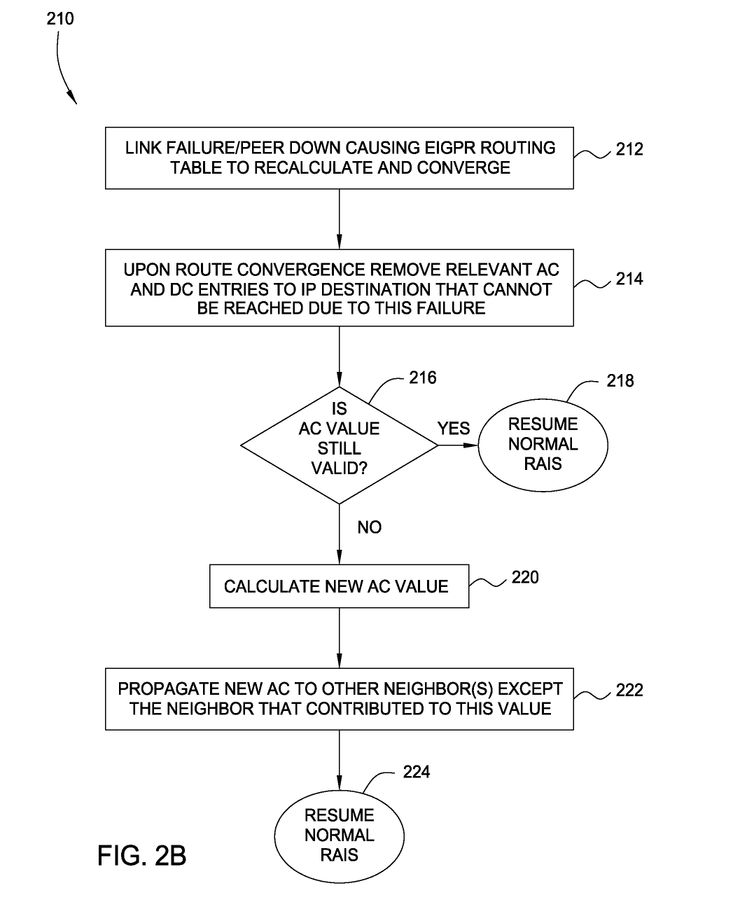

FIGS. 2A and 2B illustrate example operations 200 and 210 that may be performed to share resource availability information. For example, the RAIS operations may be performed by each node in the network in order to calculate, as well as advertise this available capacity to neighboring nodes. The operations may begin after convergence of routing tables constructed via EIGRP.

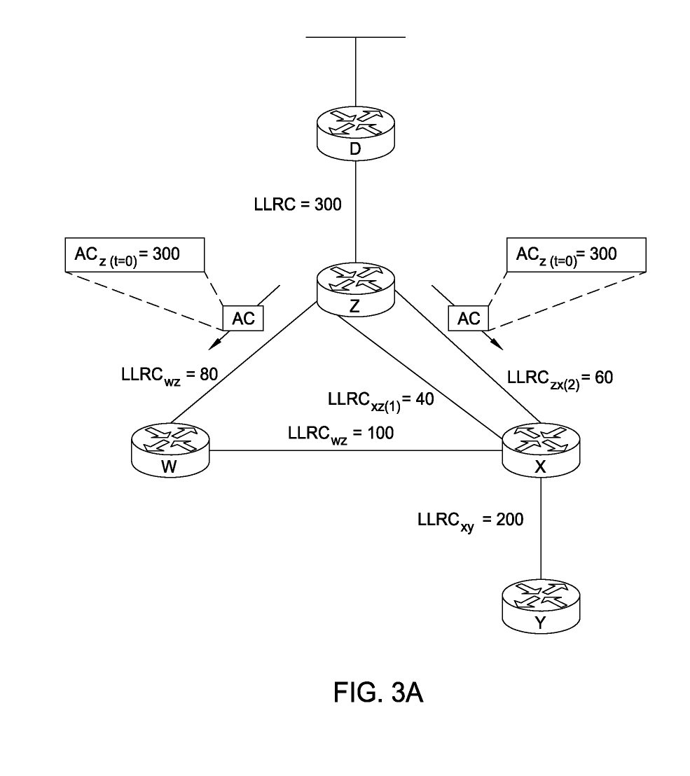

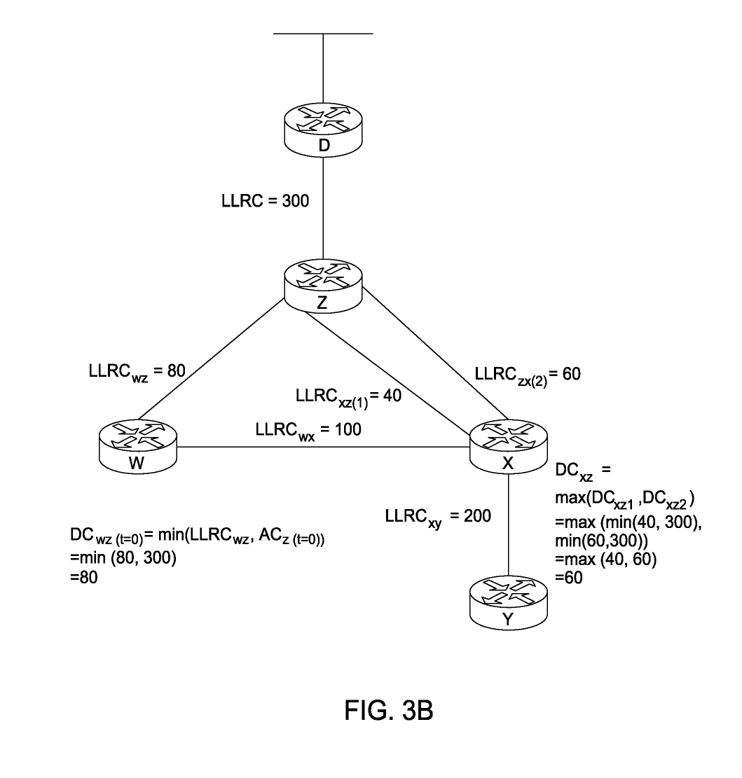

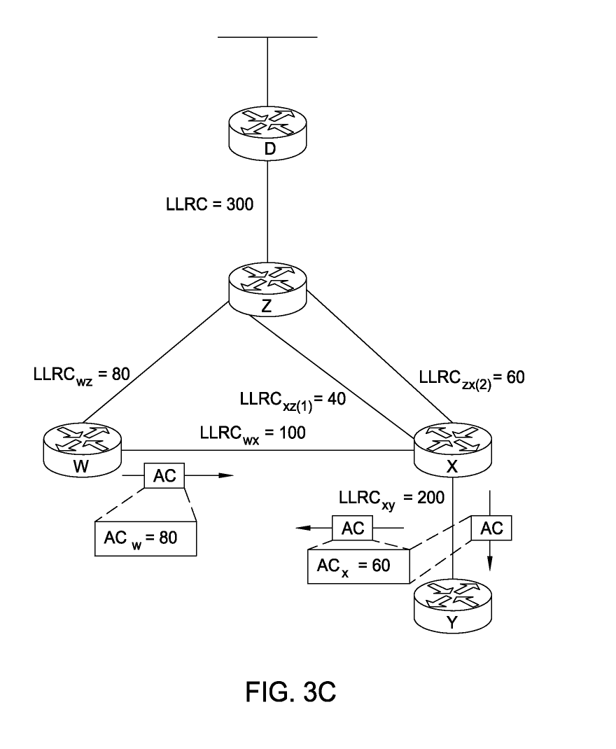

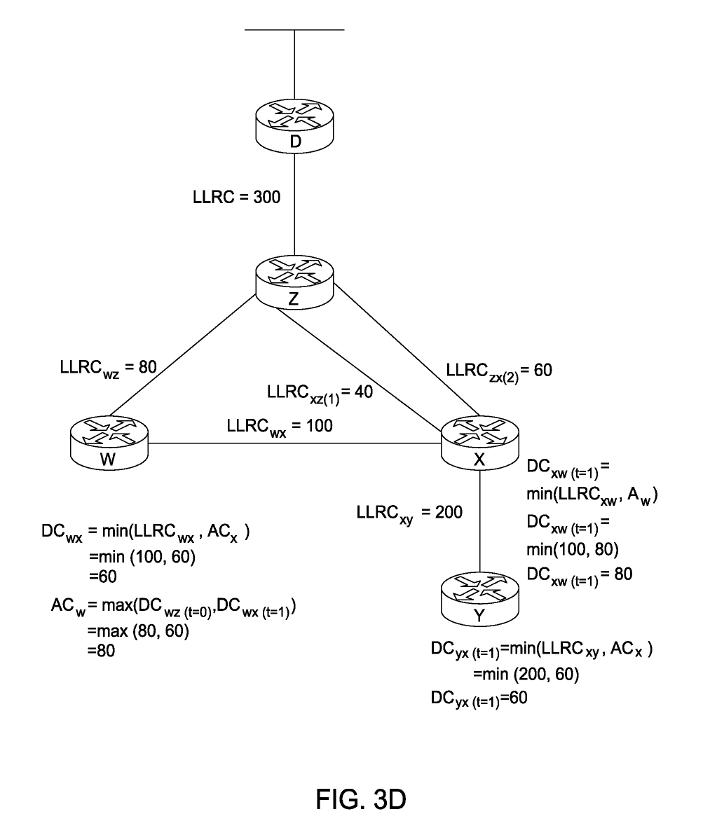

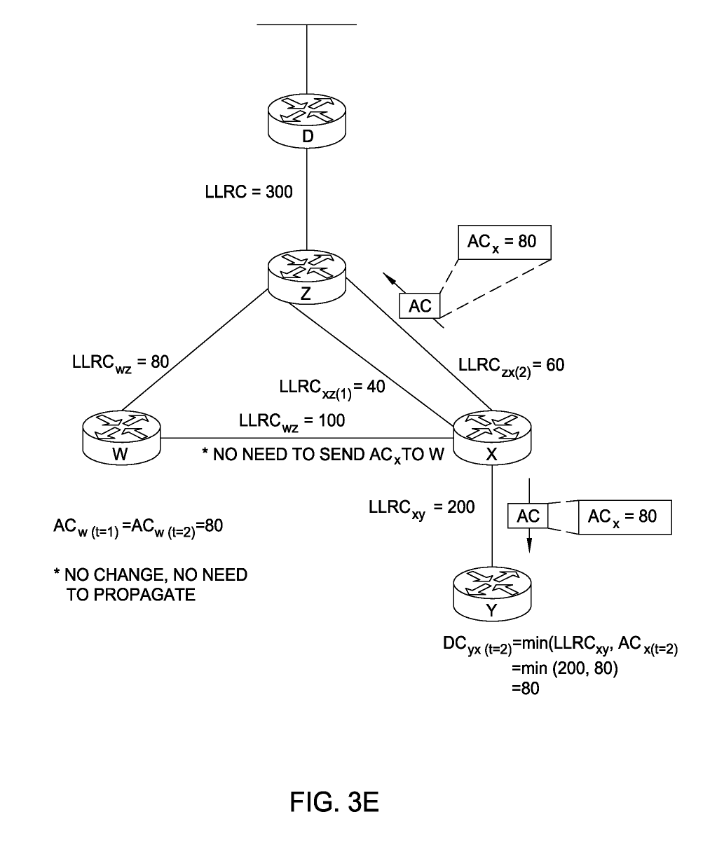

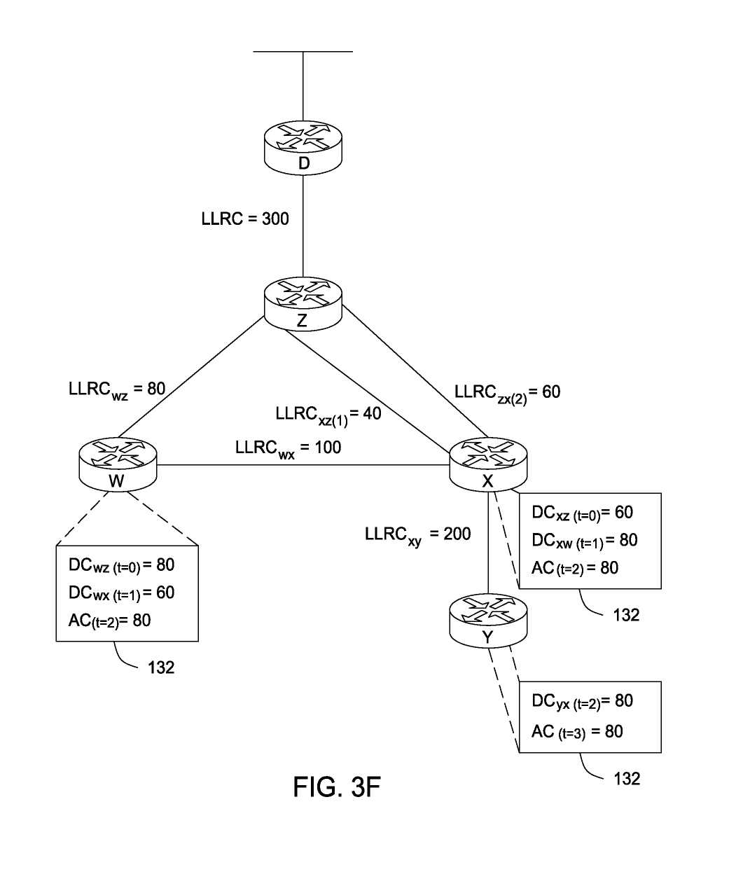

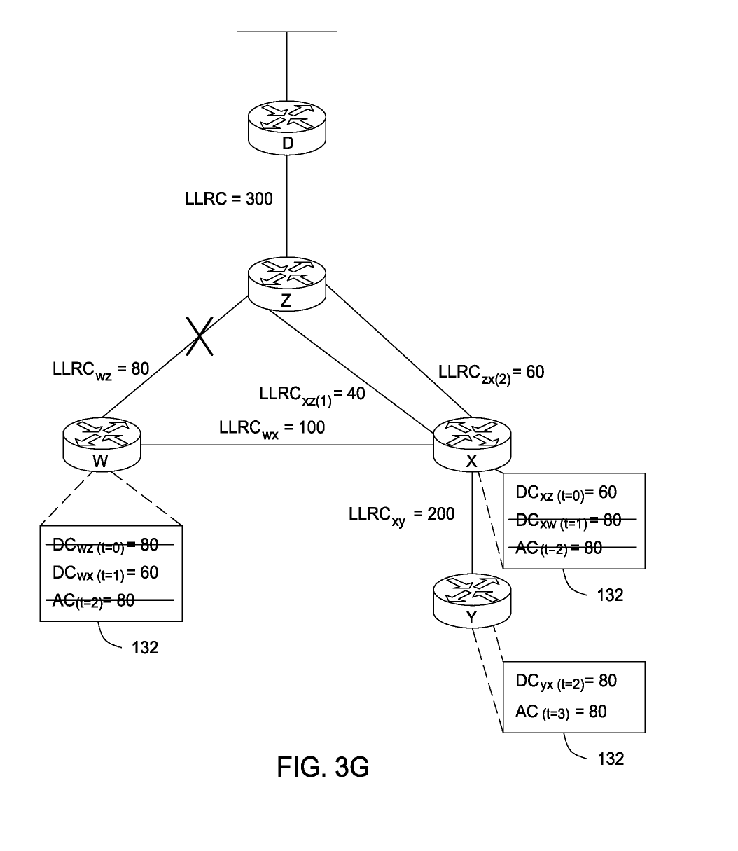

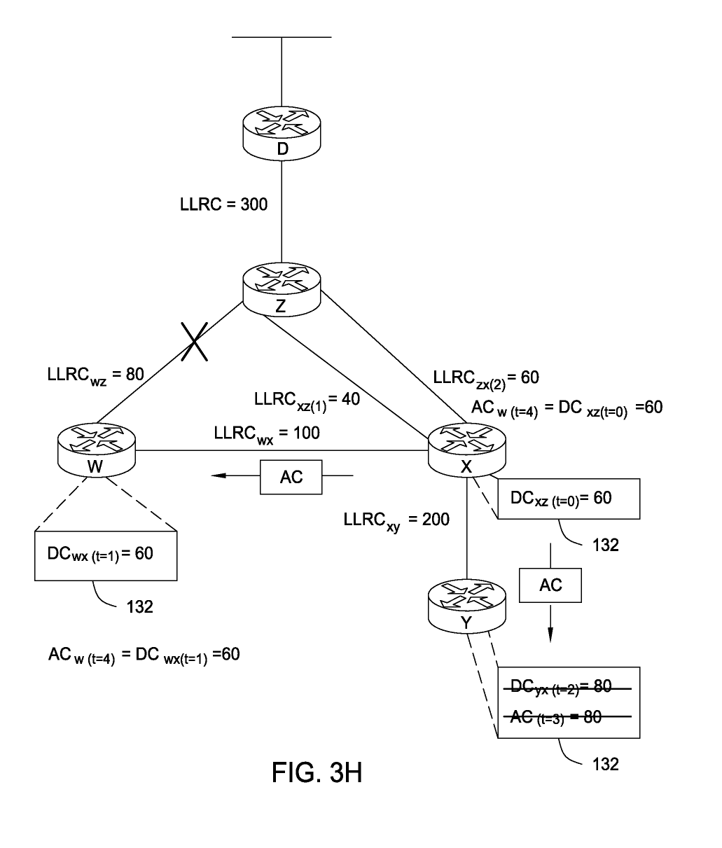

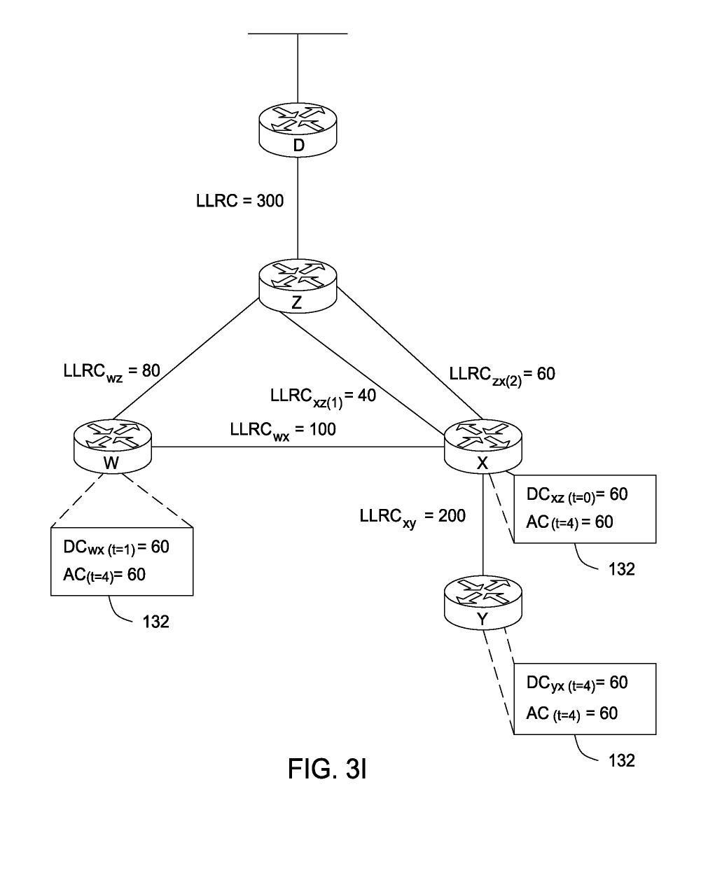

The operations may be described with reference to FIGS. 3A-3I, which illustrate example data flow for resource availability information sharing (RAIS) in accordance with embodiments of the present disclosure. To facilitate understanding, the example illustrated in FIGS. 3A-3I assumes resource availability information sharing for paths between a source node Y and a destination Node D. It should be understood, however, that similar operations may also be performed to maintain resource availability from each node to all destinations.

The operations 200 of FIG. 2A begin, at 202, by a node obtaining the LLRC for each link with an adjacent neighbor. For some embodiments, the node may check for link failures or if any peer nodes are down. As will be described in greater detail with reference to FIG. 2B, if a link failure is detected, affected derived capacity (DC) values and available capacity (AC) values may be updated to reflect the change in resource availability caused by the link failure or peer down.

At 204, a node receives AC values advertised by adjacent neighbors. At 206, for each link, a DC value is calculated based on the LLRC (for that link) and received availability capacity advertised from nodes via that link. In other words, a DC is calculated for each link on which an advertised AC was received. At 208, the maximum DC is advertised as available capacity to adjacent neighbors.

Thus, the illustrated operations in FIGS. 2A and 2B are from the perspective of a single node. The calculations may be performed on a “per IP destination” (subnet) basis, to calculate and propagate resource availability from the node to each subnet that can be discovered using a routing protocol, such as Enhanced Interior Gateway Routing Protocol (EIGRP). For some embodiments, resource availability information sharing operations described herein may begin after routing tables have converged via EIGRP.

From a system-level perspective, the operations may be thought of as happening in sequences. In general, three things take place each sequence: each node will determine what AC to advertise to neighboring nodes, each node will advertise its determined AC to neighboring nodes, and each node receiving advertised AC will calculate derived capacity (DC). This calculated DC will be used in the next sequence to determine what AC to advertise, as the operations repeat each cycle.

From an initial state, every node may begin to perform the sequence, calculating and propagating resource information to upstream neighbors. This propagation may begin with the node nearest the destination. Thus, the operations 200 may be fully performed first by one of the nodes that receives resource availability information from the node nearest the destination. Because this resource information is “pre-processed” at each downstream node, it already reflects resource availability of an entire path to the destination, not just a link to/from a nearest neighbor.

This initial propagation is illustrated in FIG. 3A, which shows the node nearest the destination, Node Z, advertising its available capacity to the destination (ACz) to neighbors, Node W and Node X. As illustrated, since this node is directly connected to the destination, the available capacity advertised by Node Z is the same as the LLRC between Node Z and Node D (AC_{Z}=300).

As illustrated in FIG. 3B, upon receipt of this advertised AC from Node Z, Nodes W and X will calculate a derived capacity (DC). DC may be considered representative of the actual available bandwidth from a node to a destination over a given link, in effect, taking into consideration the link with the least available bandwidth (i.e., the bottleneck) whether the limit is in the local link or a link in a path to the destination downstream of the local link. A node may calculate a DC value for each link (on which it receives AC advertised by a neighbor) and the maximum calculated DC may be advertised as that node's AC.

In the illustrated example, nodes W and X receive AC from only a single neighbor, Node Z, however Node X may calculate a DC for both links between Node Z and X. The DC calculation for Node W is performed by taking the minimum of the LLRC between nodes W and Z and the advertised capacity from Z:

DC_{WZ t=0}=min(LLRC_{WZ}, AC_{Zt=0})

DC_{WZ t=0}=min(80,300)

DC_{WZ t=0}=80

Node X, DC is calculated at Node X in a similar manner, but for each link:

DC_{XZ-1t=0}=min(60,300)=60

DC_{XZ-2 t=0}=min(40,300)=40

In the next sequence (t=1), Nodes W and X may determine what AC to advertise. For Node W, this will just be the DC value of 80. Node X may calculate AC as the maximum value of the DC values for the two links:

AC_{X t=1}=max(DC_{XZ-1}, DC_{XZ-2})=max(60,40)=60

FIG. 3C illustrates Nodes W and X advertising their AC values to adjacent neighbors. It should be noted that, while Node W sends its AC value to Node X, Node W does not need to send its AC value to node Z, as the value of this AC was contributed by Z. Node W sending AC to Z would only consume resources and would result in no change to AC at node Z (which is already 80). Node X sends its AC value to both Node W and Node Y, as neither of these nodes contributed to its AC value, but does not need to send its AC value to Node Z which contributed to the AC value.

As illustrated in FIG. 3D, having received advertised AC values, Nodes W, X, and Y calculate DC values. For Node W, the DC value will be:

DC_{WX t=0}=min(LLRC_{WX}, AC_{Xt=0})

DC_{WX t=0}=min(100,60)=60

For Node X, the DC value will be:

DC_{XW t=0}=min(LLRC_{WX}, AC_{Wt=0})

DC_{XW t=0}=min(100,80)=80

For Node Y, the DC value will be:

DC_{XY t=0}=min(LLRC_{XY}, AC_{Xt=0})

DC_{XY t=0}=min(200,60=60

In the next sequence (t=2), Nodes W, X, and Y will again determine the AC to advertise, based on the DC values calculated above. For Node W, this AC value is calculated by taking the maximum DC values on each link:

AC_{W t=2}=max(DC_{WZ}, DC_{WX})=max(80,60)=80

For Node X, the AC value is calculated by taking the maximum DC values on each link:

AC_{X t=2}=max(DC_{XZ-1}, DC_{XZ-2}, DC_{XW})=max(40,60,80)=80

which is an increase from the previous value of 60. For Node Y, there is only one link, hence the AC value is:

AC_{X t=2}=DC_{XY}=60.

Since this value was contributed by X and Y has no other neighbors, node Y will not propagate this value.

Since the AC value for W is unchanged from the previous AC value (AC_{W t=2}=AC_{W t=1}) there is no further propagation required by Node W. Similarly, since the AC value of Y was contributed by X and Y has no other neighbors, there is no propagation required by Node W. However, since the AC value of X has changed from its previous value (AC_{X t=2}!=AC_{X t=1}), the new AC value of X will be propagated.

FIG. 3E illustrates Node X advertising its new AC value to neighbors Z and Y. Because the AC value was contributed by W, the AC value is not sent to W. Further, because Node X is neither a Successor nor a Feasible Successor to Node Z (SEE EIGRP PROTOCOL), Node Z will simply ignore the advertised AC value. Upon receipt of the AC value from X, Node Y will again calculate a DC value:

DC_{YX t=2}=min(LLRC_{XY}, AC_{Xt=2})

DC_{YX t=2}=min(200,80)=80

In the next sequence (t=3), Node Y will calculate its AC value:

AC_{X t=3}=DC_{YXt=2}=80.

While this is a change from the previous AC value, because this value is contributed by X and Y has no other neighbors, there is no need to propagate this value. Thus, as there is no new resource availability information to propagate, the system is considered converged at t=3.

As illustrated in FIG. 3F, in this converged state, each node has resource availability information 132 that represents, from that node's perspective, the available bandwidth to the destination node D. The resource availability information at node W indicates the available bandwidth to destination D through node X is 60 (DC_{WX}=60), the available bandwidth through node Z is 80 (DC_{WZ}=80), and that this is the available capacity for it to advertise (AC_{W}=80).

In other words, through resource availability information sharing (RAIS), node Y has become aware that there available capacity of 80 to destination D, even though this capacity is on a path (X-W-Z) to D that is not the shortest path. A protocol that relied only on the shortest path calculation, on the other hand, would have selected the shortest path (X-Z), which only has available capacity of 60. Thus, network capacity may be better utilized by sharing resource availability information in the manner described herein.

FIG. 2B illustrates operations 210 that may be performed to update and propagate RAIS information to reflect a change in resource availability caused by a link failure or in the event a peer node goes down. As previously described, the RAIS protocol operations may begin after the routing tables have converged, for example, via EIGRP operations. Otherwise, the capacity information used for the RAIS calculations might not be valid. When a link breaks, the EIGRP protocol will recalculate resource capacity on available routes. Therefore, the RAIS protocol may suspend operations until the routing tables have converged. Upon convergence, the RAIS protocol may check the routing table to see what routes are new and what routes have disappeared, and update DC and AC entries as shown.

The operations of FIG. 2B begin, at 212, when a link fails or a peer node goes down, causing EIGRP routing table to be recalculated, which may cause a suspension of normal RAIS operations. Upon route convergence, at 214, a node removes relevant AC and DC entries that can no longer be reached due to the failure.

For example, FIG. 3G illustrates a link failure between nodes W and Z. In this example, EIGRP will calculate that, at node X, the route to IP Destination node D through W no longer exists. As a result, nodes W and X may actually remove the corresponding AC and DC entries, as indicated in the Figure.

At step 216, the nodes may determine if the AC value they have advertised is still valid. If so, normal RAIS operations resume, at 218. In this example, however, the AC values previously advertised by both nodes are no longer valid.

Therefore, new AC values are calculated, at 220. As illustrated in FIG. 3H, node W will calculate a new AC value of 60 based on the DC value of 60 through node X. Similarly, node X will calculate a new AC value of 60 based on the DC value of 60 through node Z.

At 222, new AC values are propagated to neighbor nodes except for those that contributed to the AC value. As illustrated, in this example, node W will not propagate its AC value to X, as X contributed to the AC value. Node X, on the other hand, will propagate its new AC value to nodes W and Y. As illustrated, the new AC value from node X will cause node Y to update its DC and AC values.

FIG. 31 illustrates the network with RAIS information, with the AC and DC values at each node converged. As illustrated, the values at each node have been automatically updated to reflect the loss of resource capacity due to the link failure between nodes W and Z. Normal RAIS operations resume, at 224.

### The Impact of Adding Nodes

It is common in the life a network for the network to change, for example, with the addition of nodes. The RAIS protocol described herein may be able to accommodate the addition of nodes, with the impact on resource availability automatically propagated to other nodes in the network as needed.

As will be shown below, the addition of nodes with better resource metrics (e.g., that provide better LLRC than existing paths), will result in propagation of its resource availability to the other network nodes to make them aware of the additional capacity. In contrast, the addition of nodes with worse resource metrics (e.g., that provide less LLRC than existing paths), will result in only limited propagation to neighboring nodes, thus conserving bandwidth.

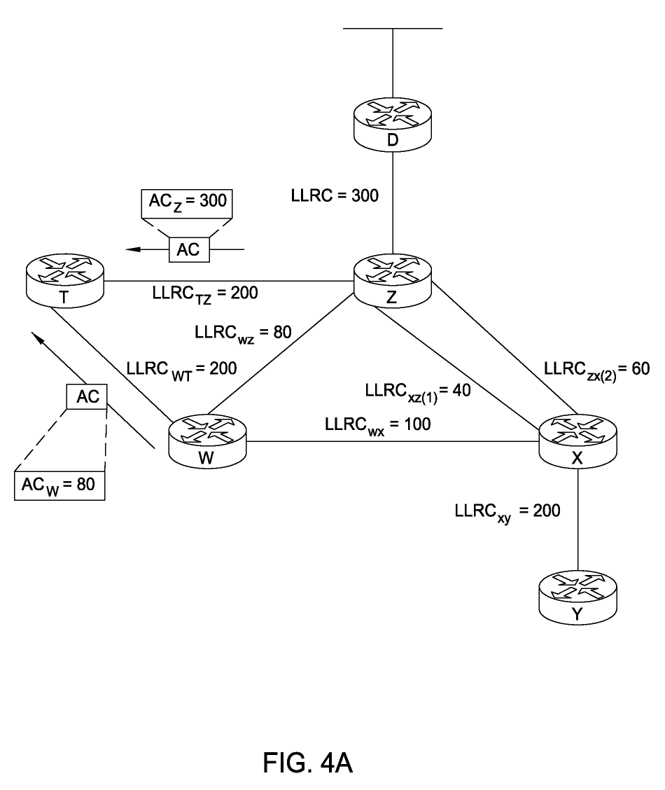

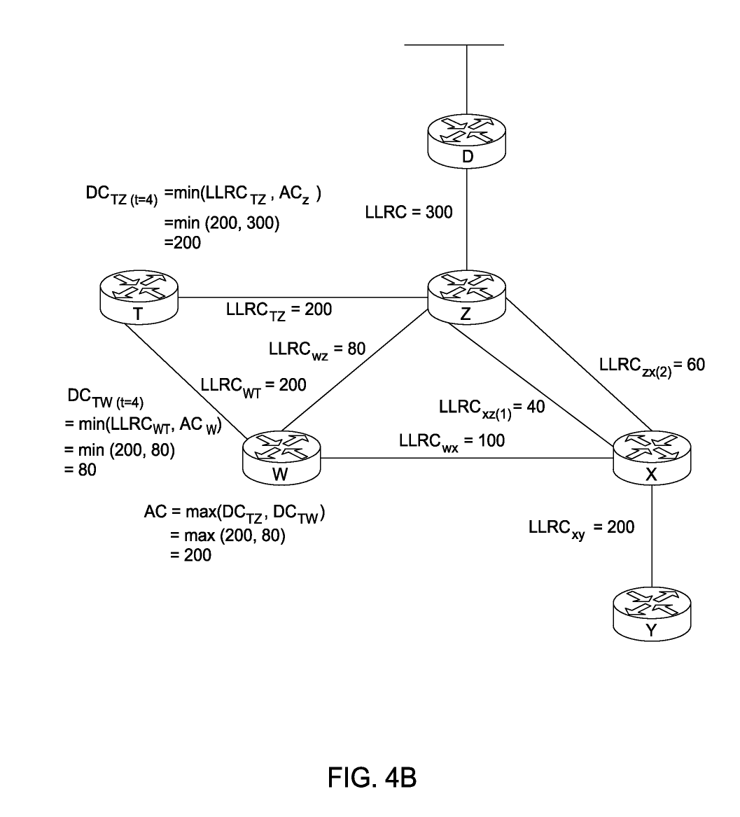

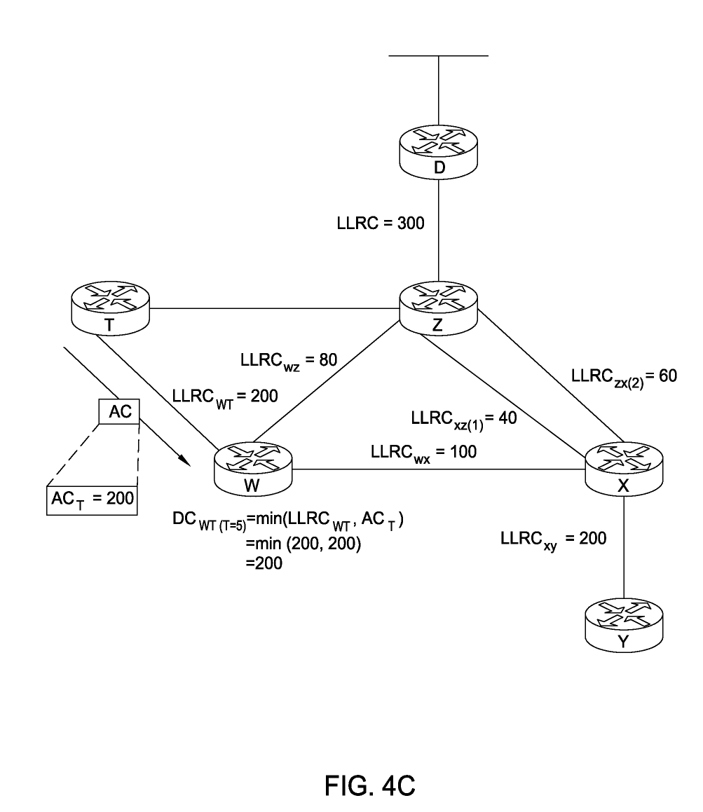

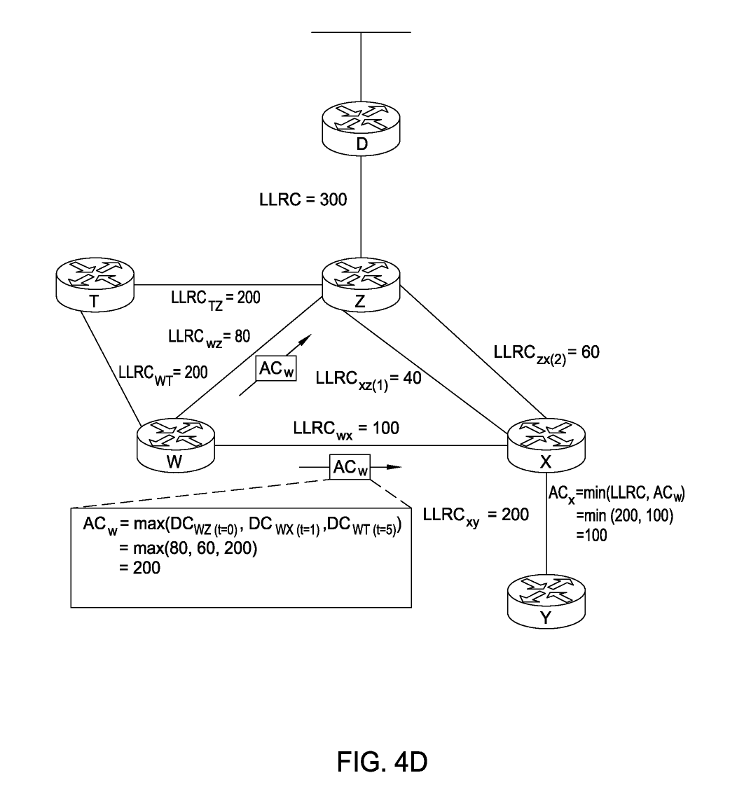

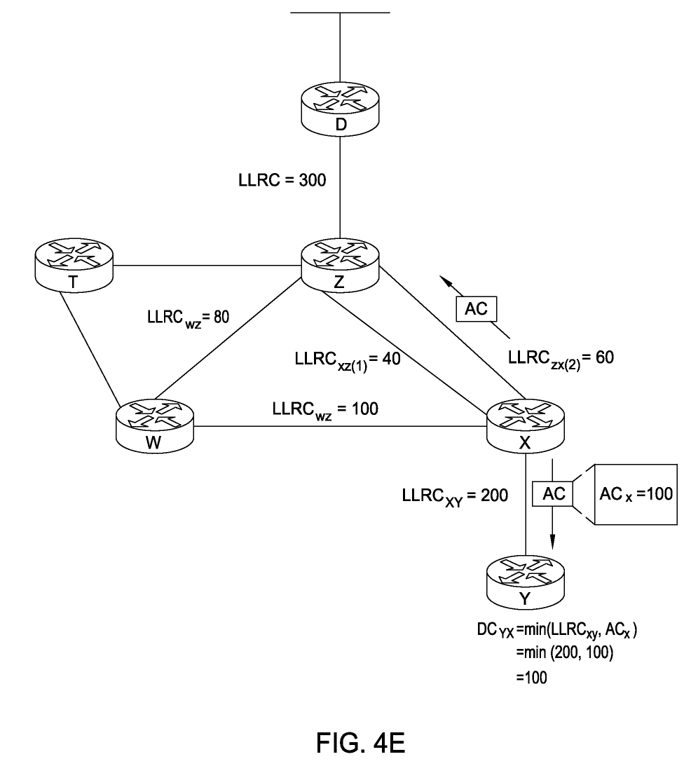

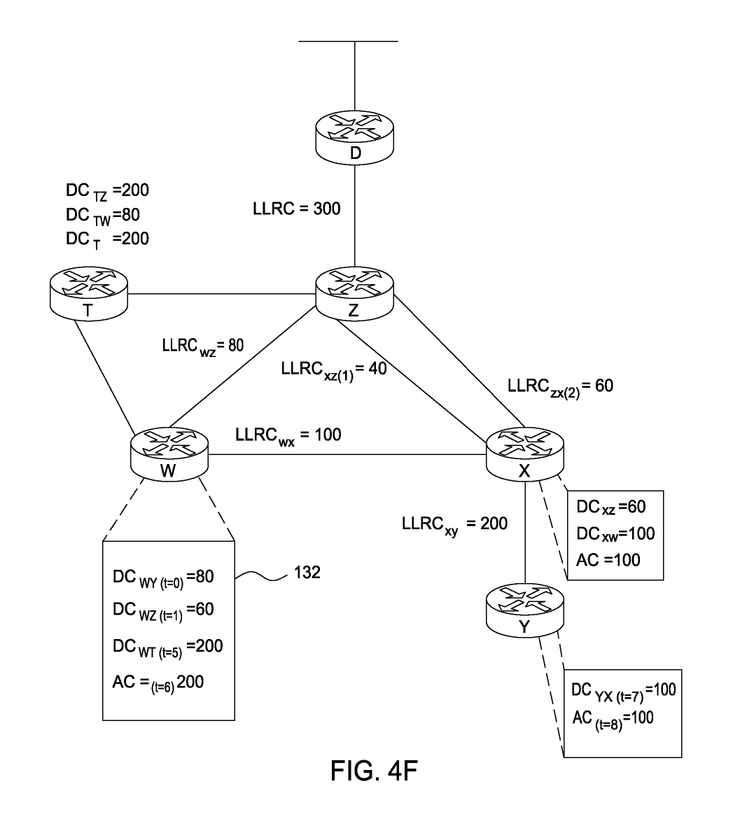

FIGS. 4A-4F illustrate the impact on RAIS when a network node with superior path metrics are added, in accordance with embodiments of the present disclosure. FIG. 4A illustrates the addition of a node T at a reference time t=4. For continuity, the illustrated example assumes the network was converged at time t=3, as shown in FIG. 3F. Thus, at the time node T is added, the other nodes have the same resource availability information values at the time of the previous convergence.

As illustrated in FIG. 4A, the integration of node T into the RAIS network begins when nodes Z and W advertise their AC values to node T. Node Z advertises an AC value of 300, while Node W advertises an AC value of 80.

As illustrated in FIG. 4B, Node T calculates DC values for the links between Node T and Nodes W and Z. The DC calculation for the link between Node T and Node Z is performed by taking the minimum of the LLRC between nodes T and Z and the advertised capacity from Z:

DC_{TZ t=4}=min(LLRC_{TZ}, AC_{Z t=4})

DC_{TZ t=4}=min(200,300)

DC_{TZ t=4}=200

The DC calculation for the link between Node T and Node W is performed by taking the minimum of the LLRC between nodes T and W and the advertised capacity from W:

DC_{TW t=4}=min(LLRC_{TW}, AC_{W t=4})

DC_{TW t=4}=min(200,80)

DC_{TW t=4}=80

In the next sequence (t=5), Node T determines what AC to advertise. The AC value for T may be calculated based on the maximum value of the DC values calculated above:

AC_{T t=5}=max(DC_{TW t=4}, DC_{TZ t=4})=max(80,200)=200

As illustrated in FIG. 4C, node T advertises this AC value to Node W, but not Node Z as Node Z contributed to the AC value. Upon receipt of the AC value from Node T, Node W calculates a DC value:

DC_{WT t=5}=min(LLRC_{TW}, AC_{T t=5})

DC_{WT t=5}=min(200,200)

DC_{WT t=5}=200

In the next sequence (t=6), Node W determines what AC to advertise. The AC value for W may be calculated based on the maximum value of the DC values for its links:

AC_{W t=6}=max(DC_{WZ t=0}, DC_{WX t-1}, DC_{WT t=5})

AC_{W t=6}=max(80, 60, 200)

AC_{W t=6}=200

As illustrated in FIG. 4D, because this AC value has changed from its previous value (AC_{W t=6}!=AC_{W t=2}) node W advertises this AC value to Nodes X and Z, but not Node T as Node T contributed to the AC value. Node Z will ignore the AC value, as W is neither a Successor nor a Feasible Successor to destination D.

Upon receipt of the new AC value from Node W, Node X calculates a DC value:

DC_{XW t=6}=min(LLRC_{XW}, AC_{W t=6})

DC_{XW t=6}=min(100,200)

DC_{XW t=6}=100

In the next sequence (t=7), Node X determines what AC to advertise. The AC value for X may be calculated based on the maximum value of the DC values for its links:

AC_{X t=7}=max(DC_{XA t=0}, DC_{XW t=6})

AC_{X t=7}=max(60,100)

AC_{X t=7}=100.

As illustrated in FIG. 4E, because this AC value has changed from its previous value (AC_{X t=7}!=AC_{X t=2}) node X advertises this AC value to Nodes Y and Z, but not Node W as Node W contributed to the AC value. Node Z will ignore the AC value, as node X is neither a Successor nor a Feasible Successor to destination D.

Upon receipt of the new AC value from Node X, Node Y calculates a DC value:

DC_{YX t=7}=min(LLRC_{YX}, AC_{Y t=7})

DC_{YX t=7}=min(200,100)

DC_{YX t=7}=100

In the next sequence (t=8), Node Y determines what AC to advertise. The AC value for X is simply the DC value calculated above:

AC_{Y t=8}=DC_{YX t=6}

AC_{Y t=8}=100

This is a change from the previous AC value, reflecting the additional network bandwidth provided by the addition of node T. However, because this value is contributed by X and Y has no other neighbors, there is no need to propagate this value. Thus, as there is no new resource availability information to propagate, the system is (again) considered converged at t=8.

As illustrated in FIG. 4F, the resource availability information 132 has been updated, relative to that shown in FIG. 3F, to reflect the additional bandwidth provided by the addition of Node T. Through resource availability information sharing (RAIS), node Y has become aware of this additional capacity (100) to destination D, on an even longer path (X-W-T-Z) to D than before. Thus, the available capacity provided by the addition of a node with better resource characteristics is automatically propagated to other nodes in the network, allowing this capacity to be better utilized.

In contrast, the addition of nodes with worse resource metrics (e.g., that provide less LLRC than existing paths) may result in only limited propagation to neighboring nodes and leave existing (better) resource availability information unchanged.

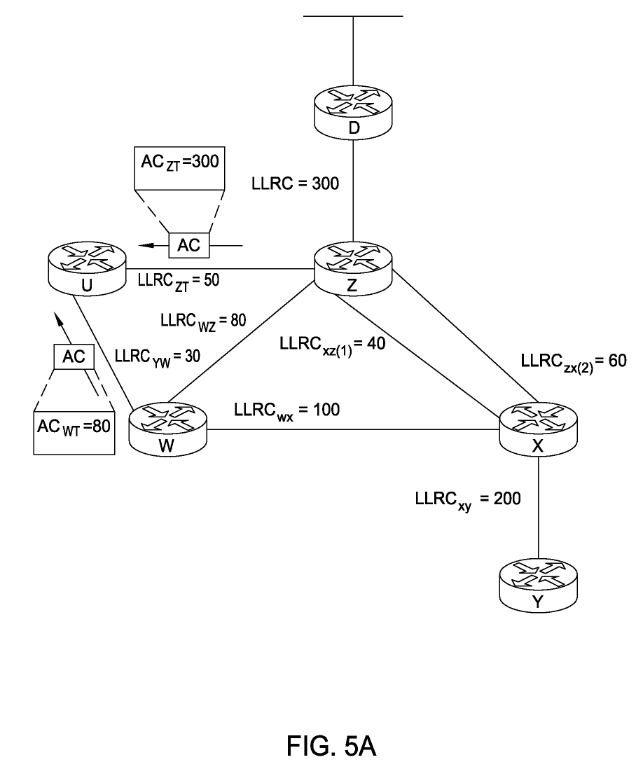

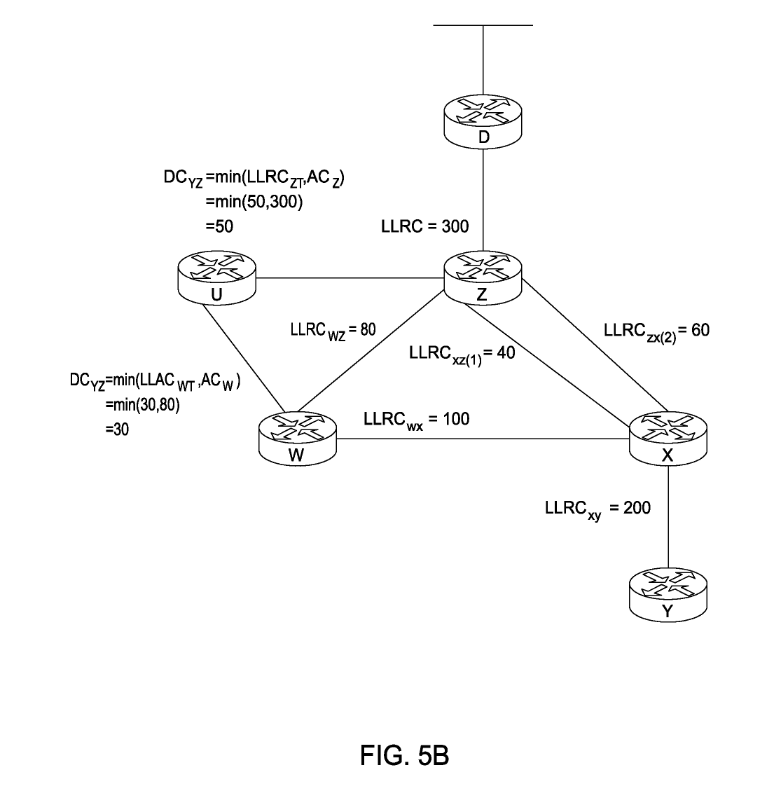

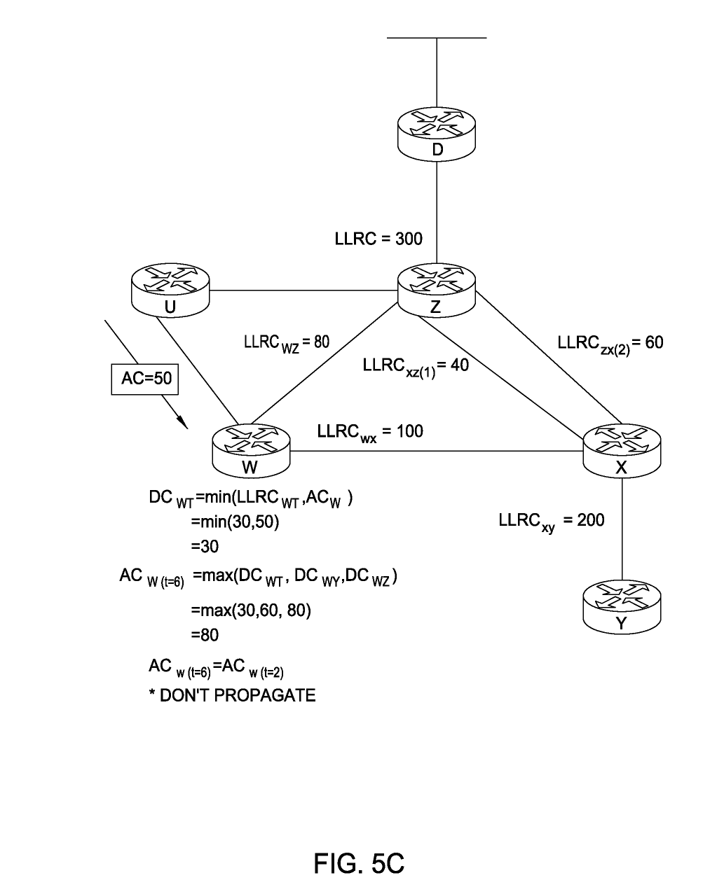

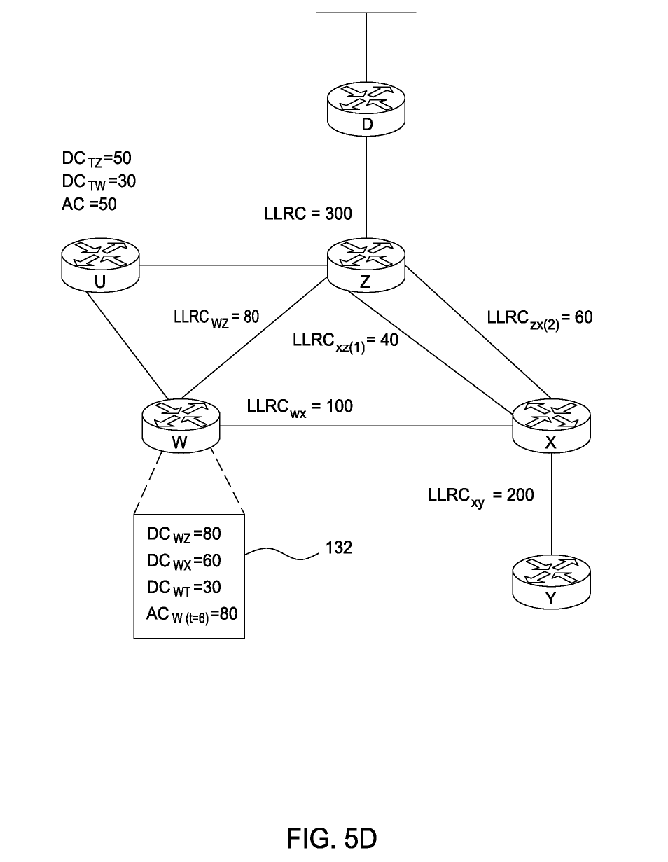

FIGS. 5A-5D illustrate the impact on RAIS when a network node with inferior path metrics are added. Again, FIG. 5A illustrates the addition of a node U at a reference time t=4, but in this example, the path metrics in the additional node are worse than what is existing.

As illustrated in FIG. 5A, the integration of node U into the RAIS network begins when nodes Z and W advertise their AC values to node U (300 and 80, respectively).

As illustrated in FIG. 5B, Node U calculates DC values for the links between Node U and Nodes W and Z. The DC calculation for the link between Node U and Node Z is performed by taking the minimum of the LLRC between nodes U and Z and the advertised capacity from Z:

DC_{UZ t=4}=min(LLRC_{UZ}, AC_{Z t=4})

DC_{UZ t=4}=min(50,300)

DC_{UZ t=4}=50

The DC calculation for the link between Node U and Node W is performed by taking the minimum of the LLRC between nodes U and W and the advertised capacity from W:

DC_{UW t=4}=min(LLRC_{UW}, AC_{W t=4})

DC_{UW t=4}=min(30,80)

DC_{UW t=4}=30

In the next sequence (t=5), Node U determines what AC to advertise based on the maximum value of the DC values calculated above:

AC_{U t=5}=max(DC_{UW t=4}, DC_{UZ t=4})=max(30,50)=50

As illustrated in FIG. 5C, node U advertises this AC value to Node W, but not Node Z as Node Z contributed to the AC value. Upon receipt of the AC value from Node U, Node W calculates a DC value:

DC_{WU t=5}=min(LLRC_{UW}, AC_{U t=5})

DC_{WU t=5}=min(200,50)

DC_{WU t=5}=50

In the next sequence (t=6), Node W determines what AC to advertise. The AC value for W may be calculated based on the maximum value of the DC values for its links:

AC_{W t=6}=max(DC_{WZ t=0}DC_{WX t=1}, DC_{WU t=5})

AC_{W t=6}=max(80,60,50)

AC_{W t=6}=80

As illustrated in FIG. 5D, because this AC value has not changed from its previous value (AC_{W t=6}=AC_{W t=2}), node W does not propagate this value to other nodes. Thus, it can be seen that when a new node is added that has relatively worse path metrics to a destination node, the remaining nodes (that have better path metrics) will not receive its resource availability information. Limiting information exchange in this manner helps conserve bandwidth.

RAIS with Applications ID Bandwidth Pools

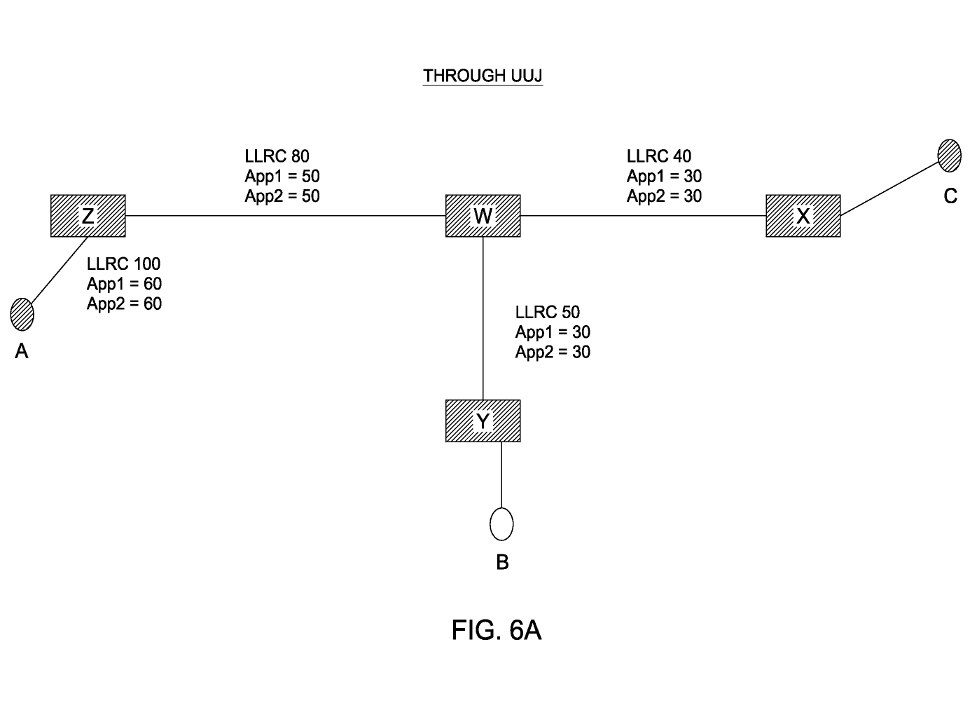

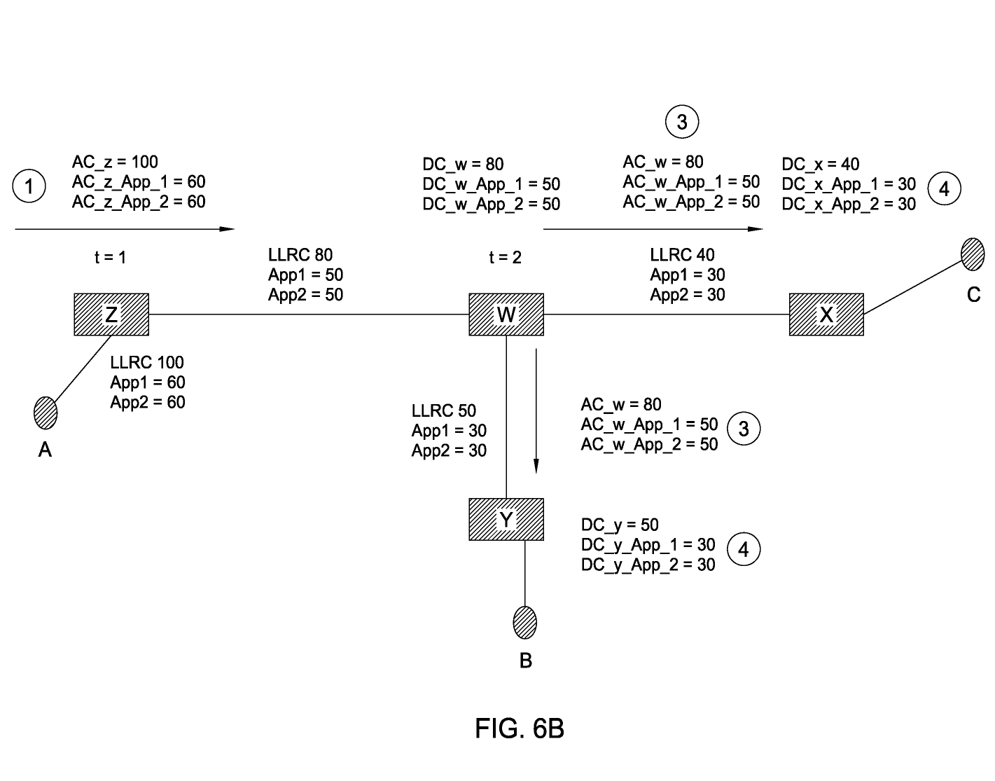

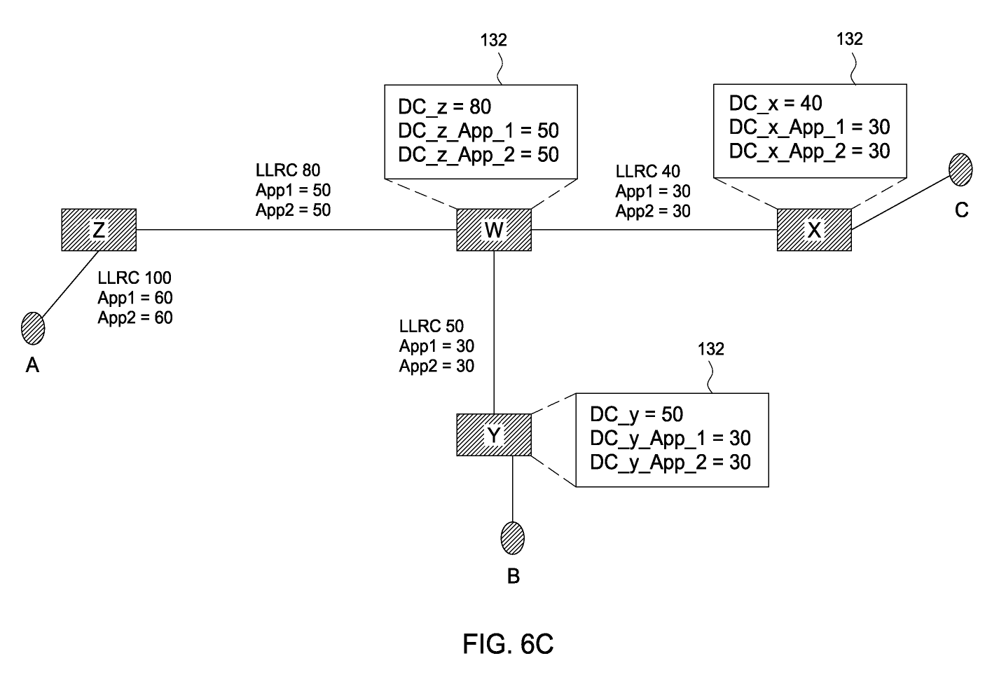

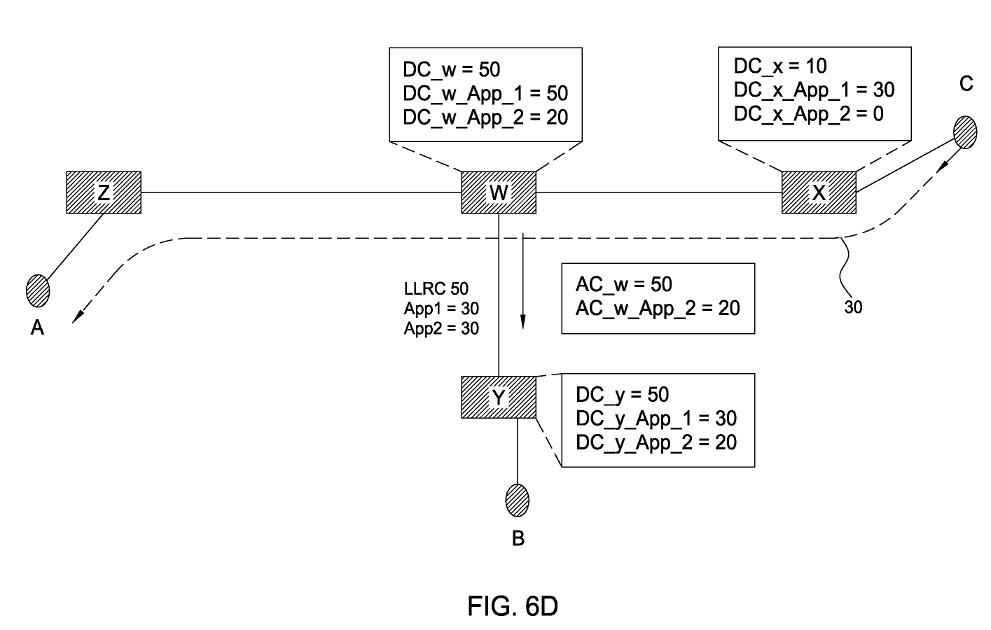

For some embodiments, resource availability information may also be maintained and shared on a per application bases, allowing RAIS to be used in networks where application pools share bandwidth. For example, referring to FIG. 6A, in addition to tracking a local link remaining capacity (LLRC) for each link, a remaining capacity available for each application may also be tracked.

As illustrated in FIG. 6B, resource availability may be shared as described above, but with RAIS AC and DC values calculated and stored for each application. Data flow during propagation leading to convergence is shown in the figure with the data transmitted in an order corresponding to the illustrated numbers.

Node Z initiates the sharing, by advertising (to Node W) an available capacity (AC) of 100 to destination A (AC_{Z}=100). In addition, node Z advertises an AC of 60 for both Application 1 and Application 2 (AC_{Z}_{—}_{APP1}=AC_{Z}_{—}_{APP2}=60). Upon receipt, Node W calculates the following DC values:

DC_{W}=min(LLRC_{WZ}, AC_{Z}=min(80,100)=80

DC_{W-APP1}=min(LLRC_{WZ-APP1}, AC_{Z-APP1})=min(50,60)=50

As W received AC from a single node, Node W advertises these same values as AC to nodes X and Y. Upon receipt, Nodes X and Y will calculate the following DC values:

DC_{X}=min(LLRC_{XW}, AC_{W})=min(40,80)=40

DC_{X-APP1}=min(LLRC_{XW-APP1}, AC_{W-APP1})=(30,50)=30

DC_{X-APP2}=min(LLRC_{XW-APP1}, AC_{W-APP2})=min(30,50)=30

DC_{Y}=min(LLRC_{YW}, AC_{W})=min(50,80)=50

DC_{Y-APP1}=min(LLRC_{YW-APP1}, AC_{Y-APP1})=min(30,50)=30

DC_{Y-APP2}=min(LLRC_{YW-APP1}, AC_{Y-APP2})=min(30,50=30

As illustrated in FIG. 6C, these values will be maintained in a converged state.

These values may be updated, however, in the event of a change in bandwidth along one of the paths, for example, due to a call using one of the applications. For example, FIG. 6D illustrates a call session between destinations C and A that takes up 30 units of bandwidth. As illustrated, changes in bandwidth are propagated along the network to reflect this reduction. For example, DC_{X} is reduced from 40 to 10 and DC_{X}_{—}_{APP2} is reduced from 30 to 0. These changes are propagated to Node W, resulting in a reduction in DC_{W} from 80 to 50 and DC_{W}_{—}_{APP2} is reduced from 50 to 20.

As illustrated, this change may be advertised to node Y, however, only the changed values are propagated. In this example, DC_{W}_{—}_{APP1} did not change, so only AC_{W} and AC_{W}_{—}_{APP2} are advertised. Upon receipt, Node Y calculates only the corresponding DC values as follows:

DC_{Y}=min(LLRC_{YW}, AC_{W})=min(50,50=50

DC_{Y-APP2}=min(LLRC_{YW-APP1}, AC_{Y-APP2})=min(30,20)=20

Thus, in this example, the only changes are to the bandwidth for Application 2, DC_{Y-APP2}, which changes from 30 to 20.

In the illustrated example, only two application IDs is assumed to facilitate understanding. However, by only propagating changes in available bandwidth, network resources are efficiently utilized, which may enhance scalability. As a result, resource availability information may be shared for a relatively large number of application IDs in the network.

### Call Setup and Rerouting Example

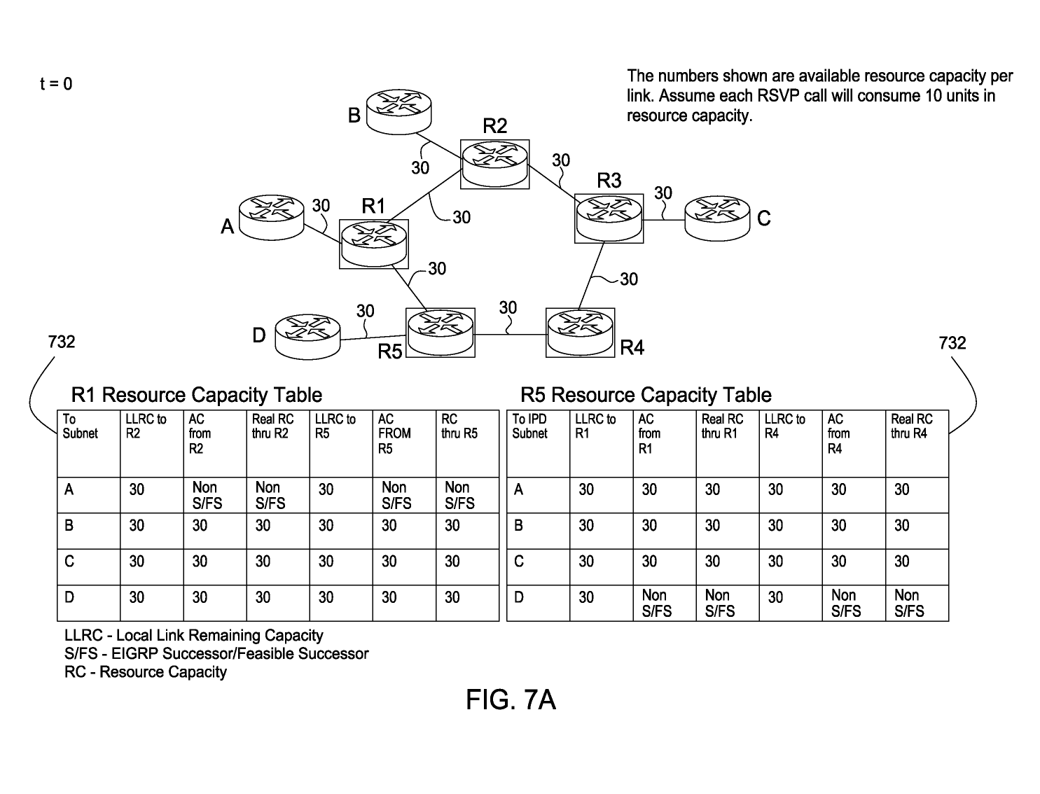

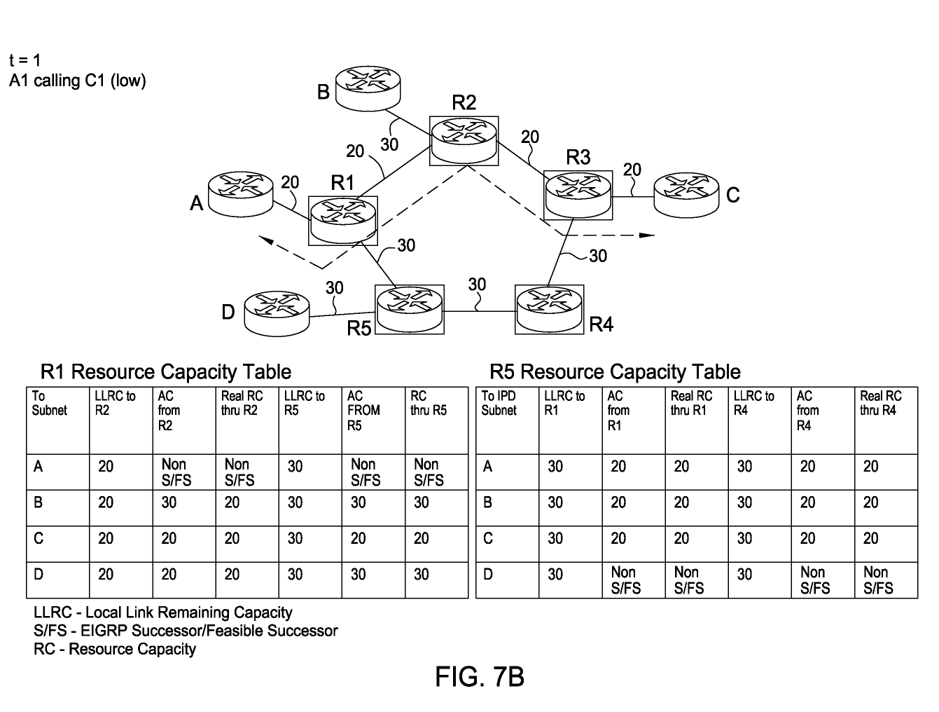

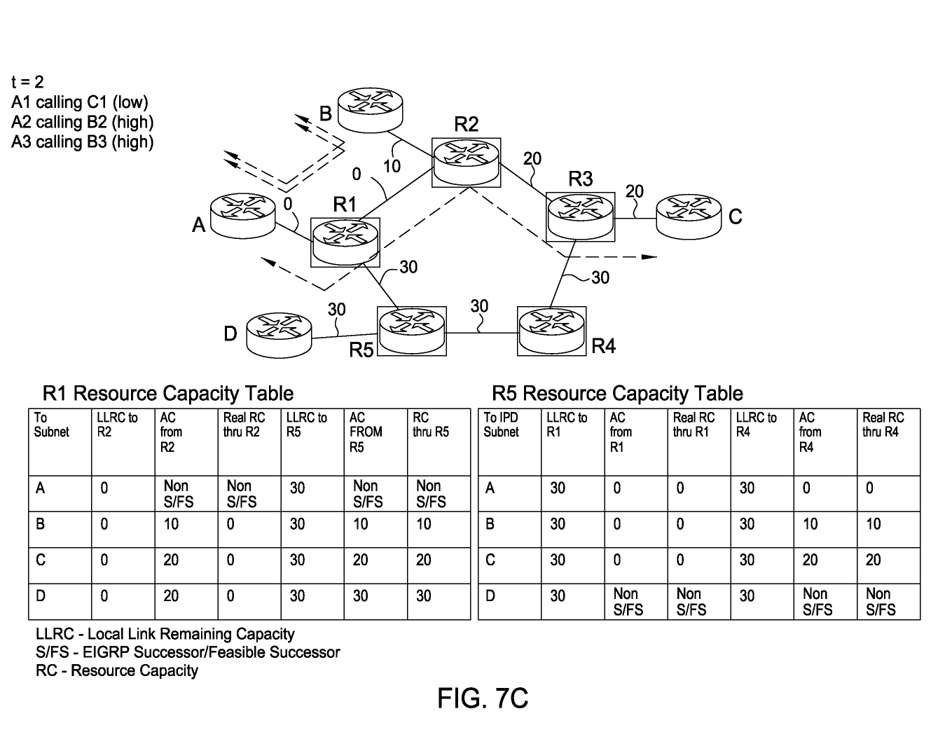

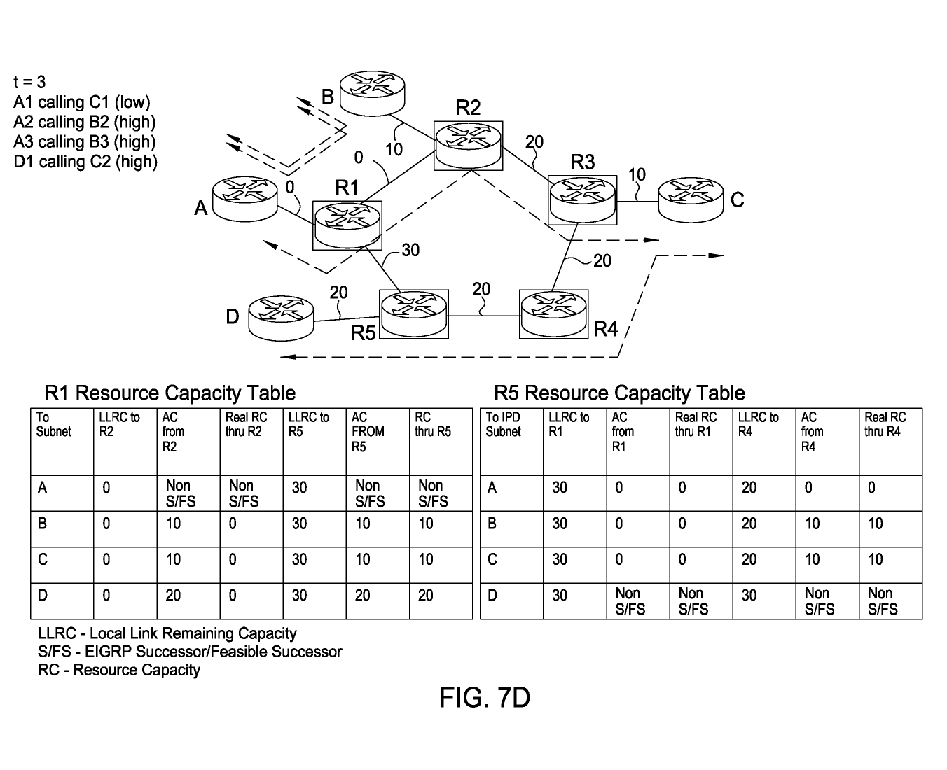

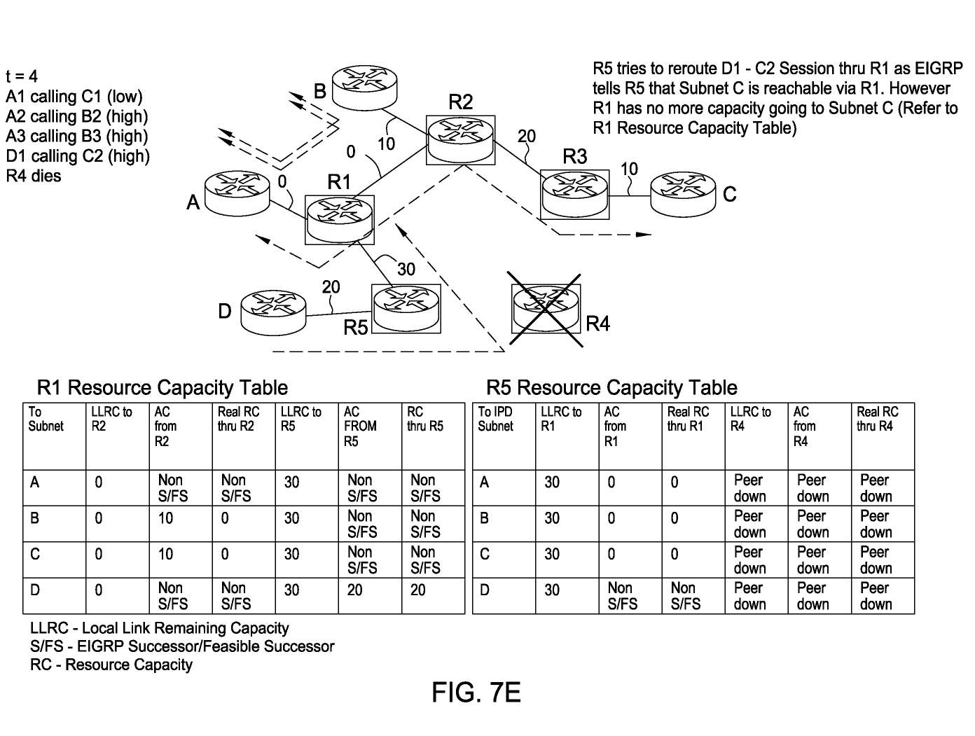

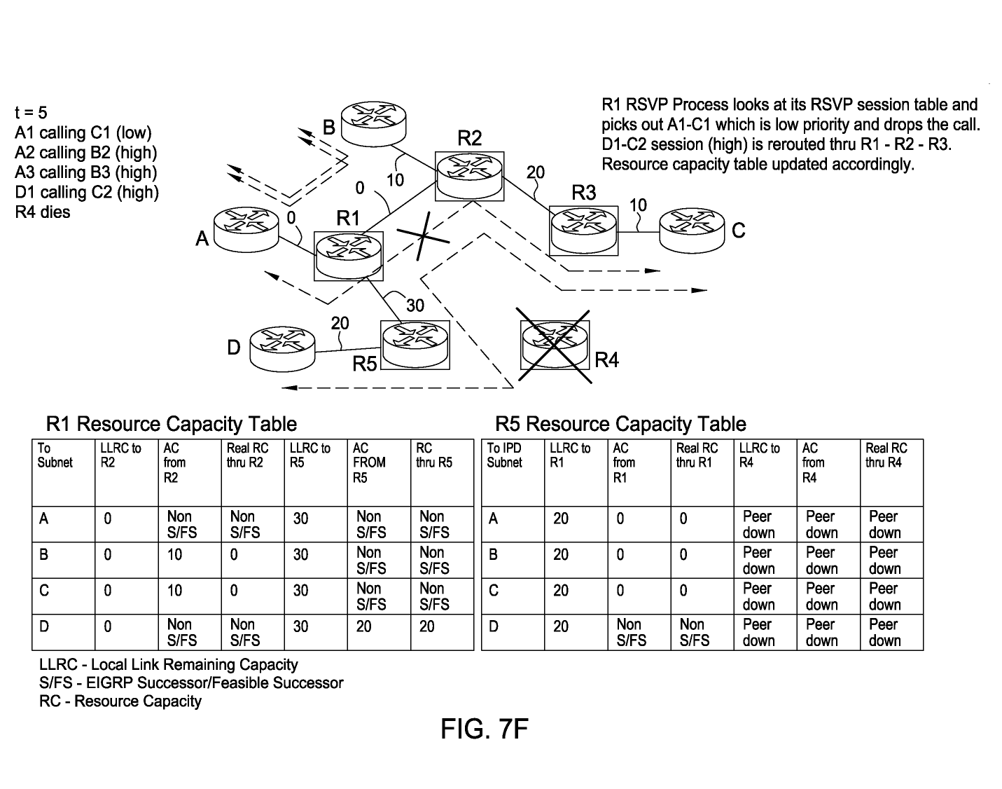

As a result of resource availability information sharing (RAIS) presented herein, all nodes in a network may have resource availability information regarding all destinations. As a result, each node may be able to make intelligent decisions in routing and re-routing traffic. FIGS. 7A-7F present an application example for RAIS with calls being setup and rerouted that illustrates how individual nodes keep track of all relevant resource capacity information.

To illustrate how each node maintains and updates resource availability information, the Figures show an example Resource Capactiy Table 732 for routers R1 and R5. The tables show parameters relative to each of four destinations A-D. In particular, each table holds the LLRC to neighboring nodes (R2 and R5 are neighbors of R1, R1 and R4 are neighbors of R5), the available capacity AC advertised by those neighboring nodes, and the derived capacity DC calculated for those nodes (the minimum of LLRC and AC). Changes in these tables, in response to events and/or information propagated from other nodes, are highlighted in each figure.

Referring to FIG. 7A, Local Link Resource Capacity (LLRC) values, initially all 30 units, are shown adjacent each link. As a result, the values in both of the tables 732 are also 30. As illustrated, if a node is not a Successor or Feasible Successor for a particular destination is also indicated.

FIG. 7B illustrates a call setup, with a low priority call from node A to node C (the priority is indicated by notation A1 to C1). As illustrated, the call consumes 10 units of bandwidth and is established along the path R1-R2-R3. As a result, resource availability information will be propagated (in the manner described above) and the final values upon convergence are shown in the tables.

Referring first to the table for R1, because the path includes R2, the LLRC through R2 to all destinations is decreased by the bandwidth consumed by the call (by 10, from 30 to 20). This also results in a reduction in the AC to destinations C and D advertised by R2, and a reduction in DC to R2 for destinations B-D. R5 is not in the path, but is affected by the call to C, as evidenced by a reduction in the AC advertised for destination C and a corresponding reduction in DC.

Referring next to the table for R5, because the path includes R1, the AC advertised by R1 and the corresponding DC values are reduced by 10. Further, because each path from R4 to destinations A, B, and C involve the call path, the AC advertised by R4 and corresponding DC values are also reduced by 10.

FIG. 7C illustrates the impact of additional calls from nodes A to B (A2 calling B2 and A3 calling B3), both with a high priority. Each call consumes 10 units of bandwidth and is established along the path R1-R2. As a result, referring to the table for R1, LLRC between R1 and R2 is exhausted, resulting in corresponding losses of DC to all destinations through R2. The AC to destination B advertised by R2 is also decreased by 10.

Referring to the table for R5, the reductions in LLRC between R1 and R2 result in a reduction in AC advertised by R1 and the corresponding DC values. Similarly, the AC advertised by R4 to destination A is zero, resulting in a corresponding zero DC value. The AC advertised by R4 to destination B is reduced by 10, resulting in a corresponding reduction in the DC value through R4 to destination B.

FIG. 7D illustrates the impact of an additional call from node D to C (D1 calling C2), with a high priority. This call consumes an additional 10 units, resulting in a reduction of AC advertised by R2 to destination C and a reduction of AC advertised by R5 to destinations C and D.

Referring to the table for R5, the additional call results in reductions in LLRC to R4. The call also results in a reduced AC advertised by R4 and a corresponding reduction in DC.

FIG. 7E illustrates an attempt to re-route a call in the event that a node dies, R4 in this example. R5 may attempt to reroute the D1-C2 call through R1, for example, based on information from EIGRP indicating that Destination (Subnet) C is reachable via R1. However, R1 has no more capacity to C (as shown in the Capacity Tables). However, in response to the request to reroute the D1-C2 call from R5, R1 may look and see if there are any lower priority calls that might be dropped (e.g., by examining an RSVP session).

As illustrated in FIG. 7F, R1 may identify the A1-C1 call, which has a lower priority and drops the call. Dropping this call frees sufficient capacity to allow the D1-C2 call to be re-routed through R1-R2-R3. The consumption in bandwidth caused by this re-routing is evidenced by a reduction in the R5 table, in LLRC through R1 to all destinations.

While the foregoing is directed to embodiments of the present disclosure, other and further embodiments of the disclosure may be devised without departing from the basic scope thereof, and the scope thereof is determined by the claims that follow.

What is claimed is:

1. An apparatus, comprising:
a resource capacity table for storing resource availability information indicating end to end bandwidth availability on multiple paths between the apparatus and a destination in a network; and
resource availability logic configured to calculate the end to end bandwidth availability based on resource capacity information received from network nodes along the multiple paths.

2. The apparatus of claim 1, wherein the resource availability logic is further configured to detect a failure of one of the paths and, in response:
update affected resource availability information to reflect the failure; and
propagate the updated resource availability to one or more neighboring nodes.

3. The apparatus of claim 1, wherein the resource availability logic is configured to calculate the end to end bandwidth availability of a path based on resource availability information received from a device along that path and an amount of bandwidth available on a link between the apparatus and the device.

4. The apparatus of claim 1, wherein the resource availability logic is further configured to:
determine a maximum end to end bandwidth availability between The apparatus and the destination on one of the paths; and
advertise the maximum end to end bandwidth availability to neighboring nodes in the network.

5. The apparatus of claim 1, wherein the logic is configured to interact with a resource reservation protocol (RSVP) process to select one of the multiple paths for establishing a call over the network based on end to end bandwidth availability rather than the length of the multiple paths.

6. A method, comprising:
receiving a first available capacity value indicative of available bandwidth between a first neighboring network node and a network destination;
calculating a first derived capacity value indicative of available capacity through the first neighboring network node to the network destination by applying a minimum function to the first available capacity value and a local link remaining capacity (LLRC) value indicative of available network capacity on a local link to the first neighboring network node;
calculating a first local available capacity value to advertise by selecting from a group of one or more derived capacity values including at least the first derived capacity value; and
advertising the first local available capacity value to one or more neighboring network nodes.

7. The method of claim 6, further comprising:
receiving a second available capacity value indicative of available bandwidth between a second neighboring network node and the network destination; and
calculating a second derived capacity value indicative of available capacity through the second neighboring network node to the network destination by applying a minimum function to the second available capacity value and an LLRC value indicative of available network capacity on a local link to the second neighboring network node;
wherein calculating the local available capacity value to advertise comprises selecting from a group of one or more derived capacity values including at least the first and second derived capacity values.

8. The method of claim 6, further comprising:
maintaining a local data structure containing at least the first available capacity value and the first derived capacity value.

9. The method of claim 8, further comprising:
updating the local data structure to reflect changes in available capacity to the network destination caused by at least one of: a change in available network capacity on the local link to the first neighboring network node and a change in available capacity through the first neighboring network node to the network destination.

10. The method of claim 9, further comprising:
consulting the data structure prior to initiating an operation that requires available network capacity to the network destination.

11. The method of claim 6, wherein advertising the local available capacity value to one or more neighboring network nodes comprises:
advertising the local available capacity value to all neighboring network nodes except the first neighboring network node.

12. The method of claim 6, further comprising:
receiving a second available capacity value indicative of available bandwidth between the first neighboring network node and a network destination;
calculating a second derived capacity value indicative of available capacity through the first neighboring network node to the network destination by applying a minimum function to the second available capacity value and a local link remaining capacity (LLRC) value indicative of available network capacity on a local link to the first neighboring network node;
calculating a second local available capacity value to advertise by selecting from a group of one or more derived capacity values including at least the second derived capacity value; and
advertising the second local available capacity value to one or more neighboring network nodes only if it is different than the first local available capacity value.

13. An apparatus, comprising:
an interface for communicating with neighboring network nodes; and
logic configured to receive available capacity values advertised by one or more of the neighboring network nodes, calculate derived capacity values indicative of actual available capacity through the one or more neighboring network nodes to the network destination, and advertise the derived capacity value that has the maximum value to one or more network nodes as the available capacity to the network destination through the apparatus.

14. The apparatus of claim 13, further comprising:
a resource capacity table, wherein the logic is also configure to store the available capacity values advertised by one or more of the neighboring network nodes.

15. The apparatus of claim 14, wherein the logic is also configured to update values in the resource capacity table based on available capacity values advertised by one or more of the neighboring network nodes.

16. The apparatus of claim 14, further comprising:
routing logic configured to consult the data structure prior to initiating an operation that requires available network capacity to the network destination.

17. An apparatus, comprising:
a resource capacity table for storing resource availability for one or more neighboring nodes;
a resource availability information sharing process configured to receive available capacity values advertised by one or more of the neighboring network nodes indicating end to end bandwidth available between the neighboring network nodes and a network destination, calculate derived capacity values indicative of actual available bandwidth through the one or more neighboring network nodes to the network destination, advertise a maximum derived capacity value to one or more network nodes as the end to end available capacity to the network destination through the apparatus, and update the resource availability information in the resource capacity table; and
a call routing process configured to consult the resource capacity table prior to initiating a call.

18. The apparatus of claim 17, wherein the call routing process comprises a resource reservation protocol (RSVP) process.

19. The apparatus of claim 17, wherein the call routing process is configured to select a path for initiating a call based on resource availability information rather than the length of the path.

20. An apparatus, comprising:
means for storing resource availability information indicating end to end bandwidth availability on multiple paths between the apparatus and a destination in a network; and
means for calculating the end to end bandwidth availability based on resource capacity information received from network nodes along the multiple paths.
